(19) United States
(12) Patent Application Publication
(10) Pub. No.: US 2018/0116466 A1
(43) Pub. Date: May 3, 2018

(54) REMOVABLE ENCLOSURE FOR A BLENDER

(71) Applicant: Vita-Mix Management Corporation, Olmsted Township, OH (US)

(72) Inventors: Alan Pilch, Olmsted Township, OH (US); David Kanning, Valley City, OH (US)

(21) Appl. No.: 15/799,317

(22) Filed: Oct. 31, 2017

Related U.S. Application Data
(60) Provisional application No. 62/415,043, filed on Oct. 31, 2016.

(51) Int. Cl. A47J 43/07; A47J 43/046

(52) U.S. Cl. CPC A47J 43/0761; A47J 43/046

(57) ABSTRACT

The present system provides an enclosure which engages the base unit with via friction fit created by one or more engagement members, so that a rotation of the enclosure and base relative to one another secures the enclosure to the base with an audible or tactile confirmation.

### CROSS-REFERENCE TO RELATED APPLICATIONS

This application claims priority to U.S. Provisional Patent Application No. 62/415,043 filed on Oct. 31, 2016, entitled “REMOVABLE ENCLOSURE FOR A BLENDER,” each of which is incorporated herein by reference in its entirety.

### TECHNICAL FIELD

The present invention relates generally to an enclosure for a blender and, more specifically, to a removable enclosure fitted onto a blender in a twistable, locking fashion to reduce noise and provide an added layer of security when the machine is in operation.

### BACKGROUND

Many electrically powered food processors, also referred to as blenders, create considerable noise when in operation. Owing to the considerable number of high speed, moving parts, mechanisms must also be employed to ensure the safe and secure operation of such machines. For example, blenders commonly employ a base containing an electric motor and its attendant controls. A container is then fitted onto this base so as to engage the drive shaft associated with the motor in order to propel one or more blades associated with the container to chop, mix, puree, or otherwise blend foodstuffs placed within the container.

A variety of enclosures fitting over or integral with the blending container have been developed, with eye toward improving the overall operation and experience in using a blender. For example, U.S. Design Pat. D427,016 discloses one such ornamental enclosure. U.S. Pat. No. RE45,655 discloses an enclosure designed to reduce the noise level of the blender by providing a hinged enclosure affording access to the container while remaining seated around the periphery of the base. Both of the patents are incorporated by reference as if fully rewritten herein.

Other approaches include hinged boxes which fully encase both the base unit and enclosure. In comparison to the patented designs noted above, these devices tend to bulky and cumbersome. Furthermore, these units may prevent the user from accessing controls and buttons located on the base unit itself.

In view of the foregoing, further improvements could be made with respect reducing noise through the use of blender enclosures. In the same manner, an enclosure that integrates with the based unit in a manner which further enhances the user's overall experience would be welcome.

### SUMMARY

The present system provides an enclosure which engages the base unit with via friction fit created by one or more engagement members, so that a rotation of the enclosure and base relative to one another secures the enclosure to the base with an audible or tactile confirmation. When so installed, the enclosure reduces noise and allows for a number of failsafe features to ensure the safe and secure operation of the blender.

In one embodiment, provided is a blender assembly that comprises a base member, said base member housing a motor. A pedestal extends from the base member and defines a peripheral edge. An enclosure provides a sound barrier to said base member, the enclosure comprises a body portion including sidewalls and a base portion that defines a cavity wherein the base portion is configured to engage the pedestal and wherein the enclosure is pivotal between a locked and unlocked position that is selectively securable to the pedestal.

The base portion of the enclosure includes an aperture that defines an opening to receive the pedestal. The base portion and the pedestal include a plurality of engagement members and a plurality of engagement channels wherein the engagement members cooperate with the plurality of engagement channels to selectively secure the enclosure to the base member. In one embodiment, the pedestal includes a plurality of engagement members and the base portion includes a plurality of engagement channels wherein the pedestal includes four engagement members and said base portion includes four engagement channels. The engagement channels include a channel for selectively receiving said engagement member, said channel may be defined by a retention lip, a guide stop, a back wall and a top wall. The aperture may be shaped to selectively receive the peripheral edge of the pedestal wherein rotation of the enclosure relative to the pedestal selectively locks and selectively unlocks the enclosure to the pedestal. Feedback confirmation may be generated by the blender assembly to identify when the enclosure is in the locked position and when the enclosure is in the unlocked position. The feedback confirmation includes an electric sensor in communication with the base unit that generates an audible signal or a visual signal.

In another embodiment, provided is an enclosure for a blender assembly that is operable to surround a blending container while on a blender, said enclosure comprises a body portion having opposed sidewalls and a rear wall with an open area opposed to the rear wall and a cover pivotally attached to the body portion to cover the open area. A base portion may be attached to the body portion, said base portion defines an aperture having a sidewall. A plurality of engagement channels may be positioned along the sidewall of the aperture wherein the engagement channels may be aligned with a plurality of engagement members positioned along a pedestal of a blender. The engagement members may be pivotal relative to the engagement channels. The enclosure may be pivotal between a locked and unlocked position to relative to the pedestal. Further, the enclosure may be rotatable relative to the pedestal to engage and to disengage the engagement members with the engagement channels. The enclosure may be rotated less than 90 degrees to selectively engage and disengage the engagement members with the engagement channels. Further, the enclosure may be rotated less that 45 degrees to selectively engage and disengage the engagement members with the engagement channels. Also, the enclosure may be rotated less than 20 degrees to selectively engage and disengage the engagement members with the engagement channels.

Also provided is a method for enclosing a blender assembly. The method comprises providing an enclosure having a base and sidewalls that define a cavity. A blender base unit having a pedestal is also provided. The base of the enclosure may be positioned on blender base unit. The enclosure may be pivoted relative to the pedestal to engage the enclosure to the blender base unit. The step of positioning the base of the enclosure on the blender base unit may further comprise receiving, in an aperture of the base, a pedestal. Additionally, a plurality of engagement members may be aligned with a plurality of engagement channels. The plurality of engagement members may be rotated relative to the plurality of engagement channels to engage the enclosure to the blender base unit. The enclosure may be rotated less than 45 degrees to engage the engagement members with the engagement channels. Also, the enclosure may be rotated less than 20 degrees to engage the engagement members with the engagement channels.

Specific reference is made to the appended claims, drawings, and description below, all of which disclose elements of the invention, as well as any of the commonly assigned patents, patent publications, and patent application serial numbers identified herein. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the invention as if fully rewritten herein.

In the drawings:

FIG. 1A is a three dimensional perspective view of certain aspects of the enclosure in an engaged, operational state.

FIGS. 1B and 1C are, respectively speaking, three dimensional perspective views of certain aspects of the enclosure in a position wherein the enclosure's engagement members are disengaged and wherein the enclosure is removed from the base unit.

FIG. 2A is a three dimensional top view, corresponding to aspects depicted in FIG. 1A, of an engagement member its engaged, operational state.

FIGS. 2B and 2C are, respectively speaking, three dimensional top views, corresponding to aspects depicted in FIGS. 1B and 1C, of an engagement member in the disengaged and removed state;

FIG. 3 illustrates a schematic plan view of an embodiment of a pedestal of a blender in accordance with the instant disclosure;

FIGS. 4A and 4B are, respectively, schematic plan views of another embodiment of the pedestal and a base of the enclosure in accordance with the instant application; and

FIG. 5 illustrates an exemplary blending system in accordance with various disclosed embodiments.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Similar reference numerals are used throughout the figures. Therefore, in certain views, only selected elements are indicated even though the features of the assembly are identical in all of the figures. In the same manner, while a particular aspect of the invention is illustrated in these figures, other aspects and arrangements are possible, as will be explained below.

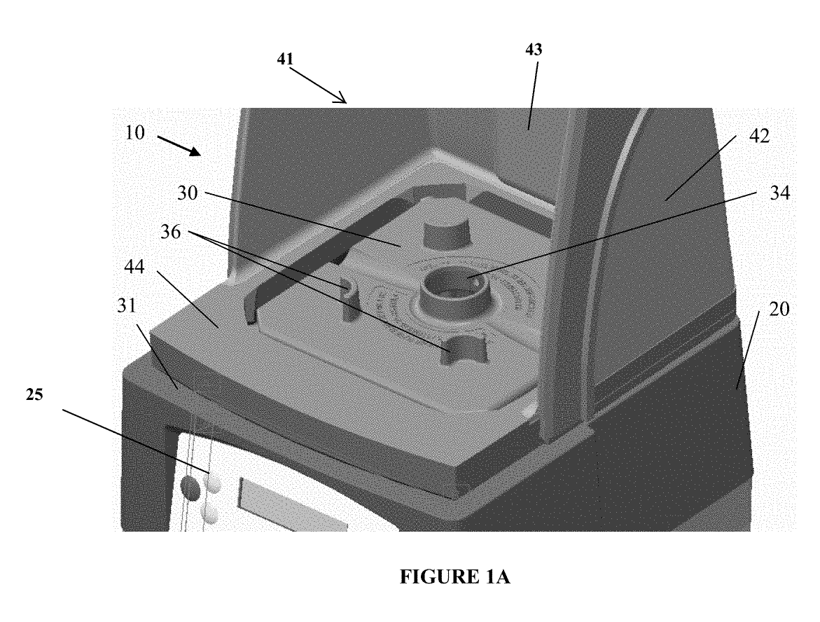

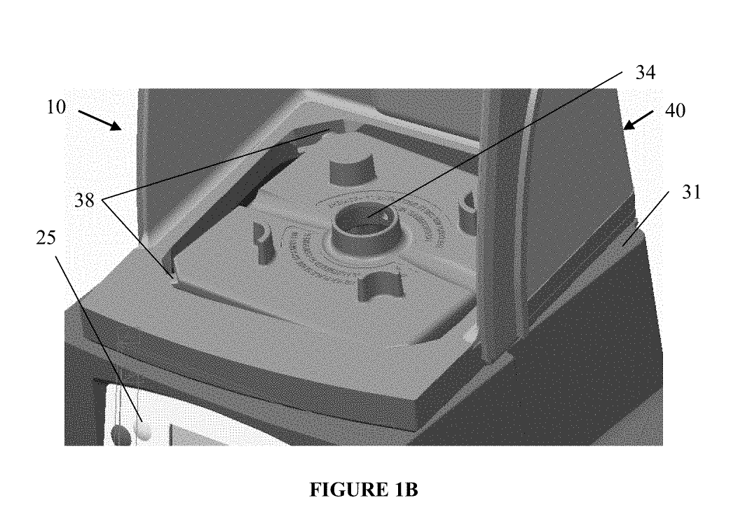

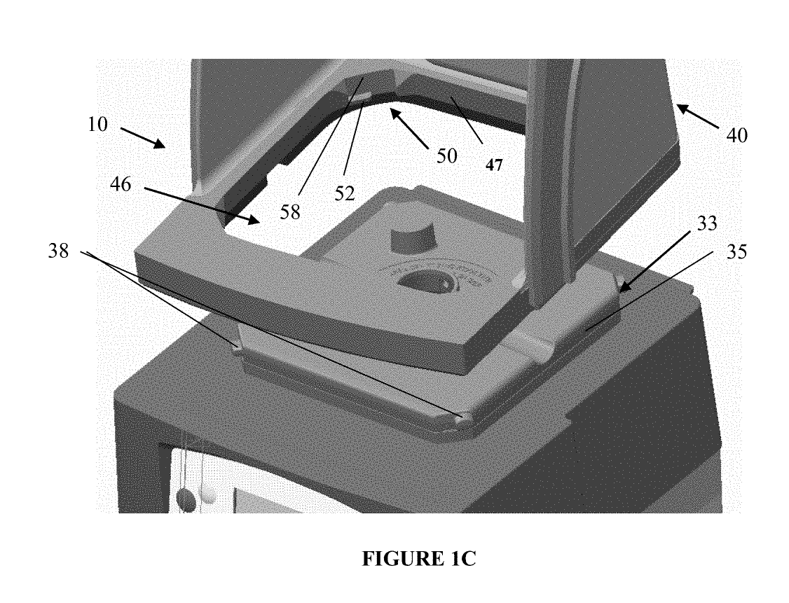

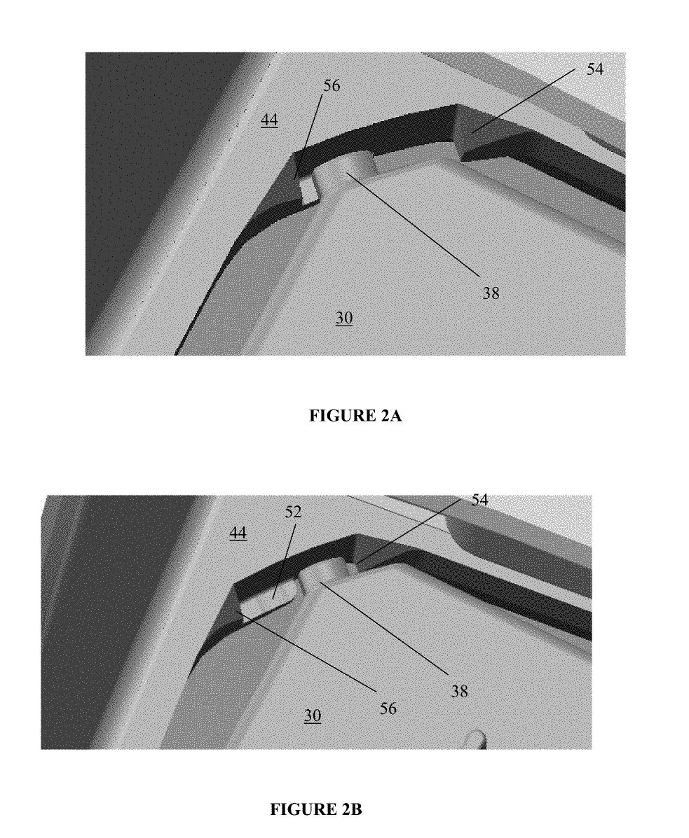

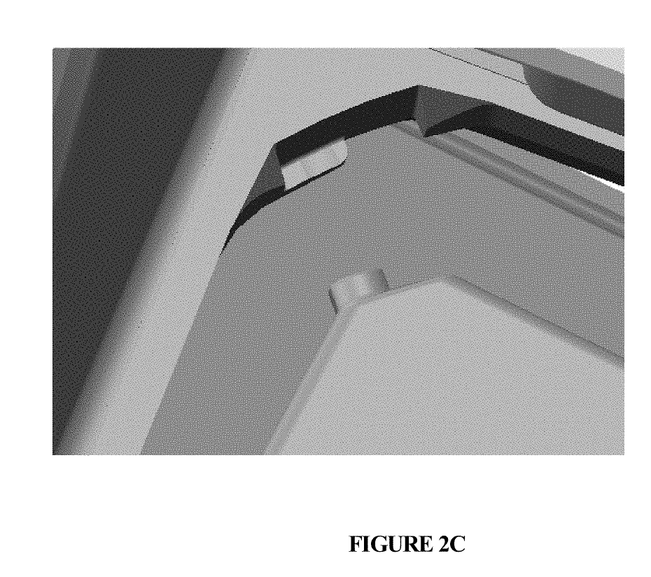

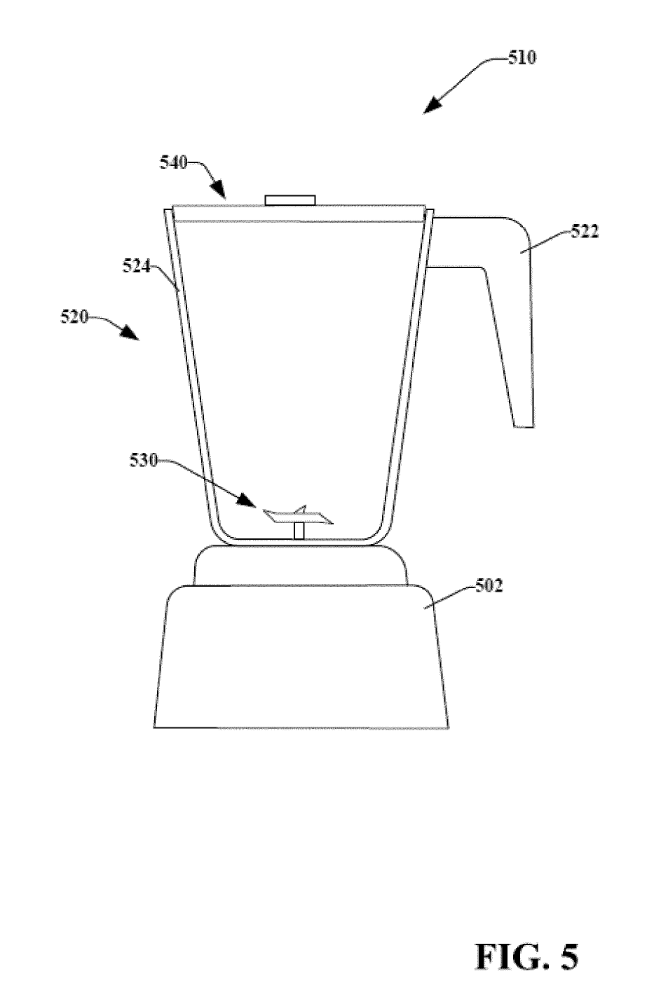

With reference to FIGS. 1A through 2C, the blender assembly 10 includes a blender base or base unit 20 and an enclosure 40. The base unit 20 encloses an electric motor (as described with reference to FIG. 5) connected to a power supply (e.g., alternating current, portable direct current power source, etc.). The motor may be controlled by control panel 25, which may include any number of interface options, including an on/off switch, pre-programmed routines for adjusting the speed and duration of blending, and the like.

Base unit 20 also includes a raised pedestal 30 on a top surface of the base unit 20, which is adapted to be received in a base portion of a container (as shown in FIG. 5). Pedestal 30 may include one or more projections 36 extending upwardly therefrom which, when received by the base portion of the container, assist to prevent the container from rotating when the motor within base unit 20 is actuated. The container may be shaped to engage the pedestal 30 at a variety of points, as will be described in more detail below.

In embodiments, the pedestal 30 extends away from the base unit 20 in order to provide a point of engagement with the container. At the same time (and as is best illustrated in FIG. 1C), a peripheral edge 31 generally adjacent to the pedestal 30 forms a seating surface for an enclosure 40. The enclosure 40 may include a base 44 having corresponding structures thereon such that one or more seals or gaskets may conform with the peripheral edge 31 and/or the pedestal 30 so as to promote a more sound-proof and/or water-tight seal. It is noted that a gasket may be disposed between at least a portion of the base 44 and the base unit 20. The gasket may generally isolate or reduce vibrations between the base unit 20 and the enclosure 40.

The top facing portion of the pedestal 30 includes a coupler 34 for engaging the blade assembly of the container. A splined drive shaft, which may extend from the blade assembly within the container, may engage a splined end of a rotating motor shaft within the coupler 34 that cooperates with the motor in the base unit 20. Rotation of the motor shaft caused by actuation of the motor is thereby transferred to the draft shaft and the blades rotatably positioned within the container. As such, the coupler 34 may include a complementary shaped end associated with the motor that is engageable with a shaft of the blade assembly to drive the blade assembly in the container. The one or more projections 36 may also be formed on the top facing of the pedestal 30 to better secure the container to the base unit 20. In some aspects, a plurality of projections 36 are formed with shapes that cooperate with corresponding recesses in the container.

The enclosure 40 includes a body portion 41 having opposed sidewalls 42 spanned by a rear wall 43 wherein the sidewalls 42 and rear wall 43 extend upwardly from the base 44 and define a cavity. The base 44 and the walls 42, 43 may be monolithically formed to one another or may be made by separate components attached to one another. The body portion 41 may include an open front area opposed to rear wall 43, which front area may be closed by a cover (not shown) to form the enclosure 40. The enclosure 40 may be designed to generally surround the container as it is positioned on the pedestal 30. The cover may be hinged to open and close the enclosure 40 to allow for access therein and to allow the container to be positioned on the pedestal or be removed. In another aspect, a gasket may be disposed between the cover and one or more of the walls 42, 43. It is noted that gaskets may be utilized as described with reference to U.S. patent applications RE45,655 and RE45,308, the entireties of which are incorporated by reference herein. The entirety of the enclosure 40, including the base 44, side walls 42, rear wall 43 and cover 40 may be selectively attached to the pedestal 30.

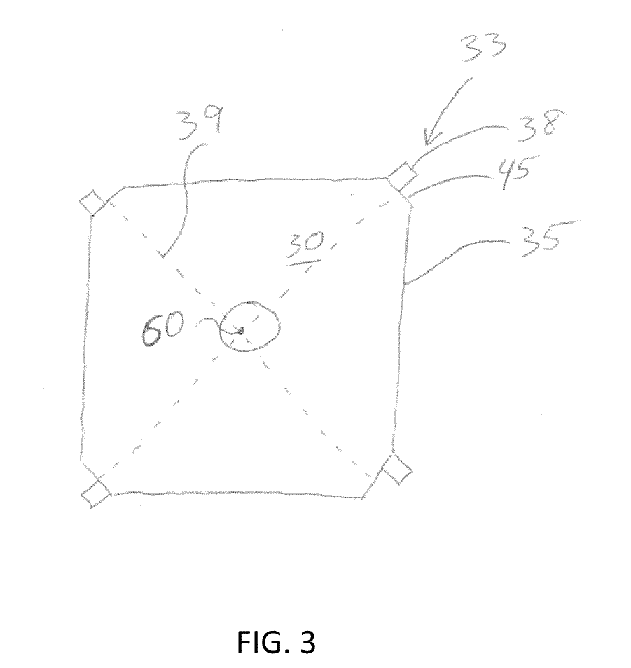

The pedestal 30 may also include a shape that cooperates with an aperture 46 in the enclosure 40. For example, pedestal 30 may have a substantially square or rectangular profile when viewed from the top, with recessed or rounded edges 33. Other pedestal shapes are possible, including ovals or circles with flattened portions serving as the recessed edges and/or regular or irregular polygons. Engagement members 38 may extend orthogonally from pedestal sidewalls 35 as illustrated by FIG. 1C. In certain aspects, members 38 are provided along the recessed edges 33 in an arrangement wherein the members 38 all align with a central radius 39 wherein they may extend a common distance from a central axis 60 (FIG. 3). At least one member 38 is required, with additional members being preferred. In certain embodiments, four engagement members 38 are provided at the recessed edges 33 of a platform having a four-sided shape (when viewed form the top). In one embodiment, the rounded edges 33 may include a flat portion 45 adjacent to the engagement member 38.

Engagement members 38 cooperate with engagement channels 50 formed in a peripheral edge 47 of the base 44 of enclosure 40. The peripheral edge 47 may generally define the aperture 46 within the base 44 wherein the aperture 46 may have a size that cooperates with the perimeter of the pedestal 30 to allow for the pedestal 30 to be received therein. As the pedestal 30 is received within the aperture 46, engagement members 38 may be aligned with and received within the engagement channel 50. The engagement channel 50 may include a retention lip 52, a guide stop 54, a back wall 56, and a top wall 58. After the pedestal 30 is received within the aperture 46, the enclosure 40 may be pivoted such that the engagement members 38 may be aligned through the channel 50 and into a locking position adjacent to the back wall 56. The engagement members 38 may frictionally about along the retention lip 52 and be positioned towards the back wall 56 when the enclosure 40 is pivoted into an engaged position with the pedestal 30.

Further protrusions, friction-fitting grooves, spring-loaded pegs, or other similar mechanisms may provide nominal resistance and/or produce an audible clicking sound to alert the user when the members 38 are in the engaged/locked position. In the same manner, a pressure/load sensor, a contact circuit, and/or magnets coupled to reed switches may provided in these respective parts, along with appropriate circuitry in the base unit 20 to provide an indication when the enclosure 40 is properly positioned. In some aspects, this indication may involve visual and/or audible aspects, such as light emitting diode indicators, a graphical display, an alert signal, a voice message, and the like. In further aspects, operation of the motor may be made contingent upon sensing proper installation of the enclosure.

Additional locking mechanisms might be provided so as to better secure and attach the enclosure to the base. For example, by way of additional projections, activation of electromagnets, and the like. These additional locking mechanisms can be designed so that they can be release while the motor is in operation. Additionally or alternatively, the additional locking mechanisms might be latches, pegs, or fasteners located at the interface of the peripheral edge 31 and enclosure 40 which the user positions before the motor can be engaged. Additionally, a bottom portion of the base 44 may rest on the peripheral edge 31 of the base unit 20 when the enclosure 40 is in the engaged or locked position. In this configuration, the outer walls

The entirety of the enclosure 40, including the base 40, side walls 42, and the top portion including a pivoting opening (not shown), may be rotated relative to the base unit 20 to allow for such tactile engagement. While the aperture 46 in the figures is shown to have a substantially similar shape as that of the pedestal 30 (i.e., generally square), it may be possible to provide differing shapes for the pedestal and enclosure so long as sufficient engagement between the pedestal 30 and the enclosure 40 can be achieved at a plurality of points (e.g., a circle fitting within a square, etc.). Additional structure may be included in the channel 50 and/or along other contact points between the base 44, walls 35, and/or peripheral edge 31, and these portions may be partially constructed from materials which present resistance/friction when they are slid across their intended range of motion. Guides may also be fashioned in the peripheral edge 31 to simplify locating the proper orientation of the enclosure and base.

To disengage the enclosure 40 from the pedestal 30, the enclosure may be pivoted oppositely from the initial direction wherein the frictional engagement between the engagement members 38 and the retention lip 52 of the engagement channel 50 is overcome. Notably, feedback notice may be generated in the form of a tactile pulse to the user, audible sound, visual display, or any combination of these notices.

The materials of the base 20, pedestal 30, and enclosure 40 may of any type, although durable, moldable polymers may be particularly useful. Metal, glass, and ceramics may also be used. In the same manner, gaskets may be interposed at any of the contact points (i.e., enclosure to peripheral edge, within the engagement channel, etc.) to allow for a better seal. Such gaskets may be formed of amorphous polymers, semicrystalline polymers, biopolymers, bitumen materials, and the like.

In one embodiment, the pivoting of enclosure 40 relative to base 20 may be in the form of a slight rotation in a single, horizontal plane with a circular rotation between the elements. However, three dimensional movements could be accommodated in certain aspects as the engagement members 38 and the engagement channels 50 may be provided in various orientations relative to one another to accomplish various pivoting movements. For example, channel 50 could be formed to include a retention lip 52 having a have twisted or screw-like shape. In such aspects, the final resting place for the member 38 could be provided as a plateau and/or with a resting groove. In the same manner, the members 38 and channels 50 need not be symmetrically situated, and varying elevations or positions could be used so as to prevent improper installation of the enclosure 40. In the same manner, the relative shape of the enclosure 40, its base 44, the pedestal 30, and/or the base unit 20 can be fashioned to provide additional visual cues for the user as to the correct installation. As noted above, electronic mechanisms, including reed switches, magnetic switches, proximity or load sensors, and other similar devices, can be employed in the base, the container, and/or other components for purposes of verifying installation, as well as allowing or preventing operation of the blender itself under certain conditions. In another aspect, NFC sensors or other wireless sensors may be utilized to determine whether the enclosure 40 is attached to the base unit 20.

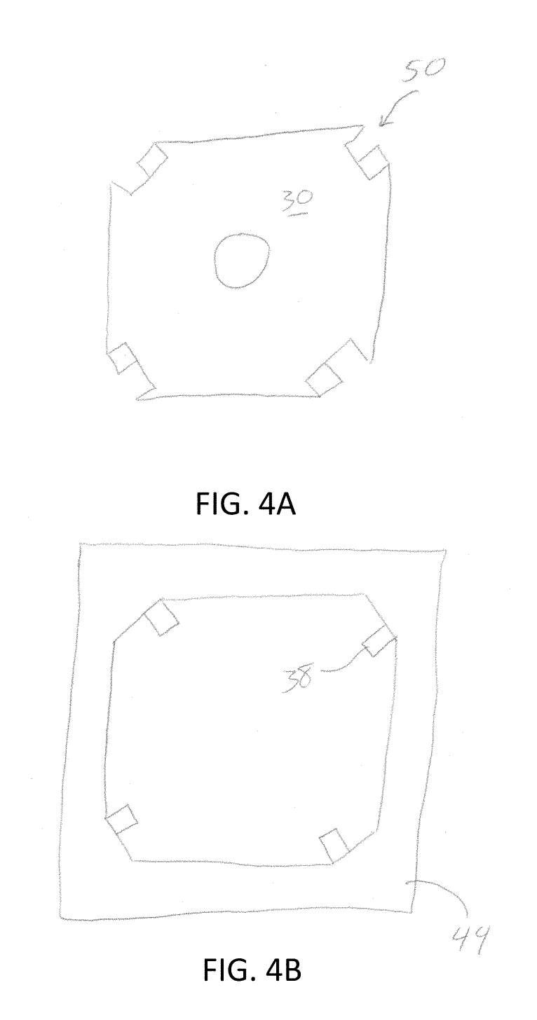

In another embodiment as illustrated by FIGS. 4A and 4B, the engagement members 38 may be positioned along the aperture 46 of the base 44 and the engagement channels 50 may be positioned along the pedestal 30. This rearrangement of members relative to each other may also include various orientations wherein the pedestal 30 may include both engagement members 38 and engagement channels 50 and the base 44 may include both engagement members 38 and engagement channels 50. These staggered orientations may also allow for the alignment of the engagement members to the engagement channels to achieve pivotal connection between the enclosure 40 and the base unit 20.

FIG. 5 illustrates an exemplary blending system 500 in accordance with various disclosed embodiments. System 500 may utilize various disclosed aspects. For instance, system 500 may include an enclosure 40 as described with reference to FIGS. 1-4.

System 500 primarily includes a blender base 502, a container 520 operatively attachable to the blender base 502, a blade assembly 530 (which may include a bifurcated seal), and a lid 540 that may be operatively attached to the container. The container 520 may include walls 524 and a handle 522. Foodstuff may be added to the container 520 for blending. It is noted that the container 520 may comprise various materials such as plastics, glass, metals, or the like. In another aspect, container 520 may be powered in any appropriate manner.

The blade assembly 530, container 520, and base 502 may removably or irremovably attach. The container 520 may be powered in any appropriate manner, such as disclosed in U.S. patent application Ser. No. 14/213,557, entitled Powered Blending Container, which is hereby incorporated by reference. While shown as a large-format system, system 500 may comprise a single serving style system, where the container is filled, a blender base is attached to the container, and then the container is inverted and placed on a base.

The base 502 includes a motor disposed within a housing. The motor selectively drives the blade assembly 530 (e.g., cutting blades, chopping blades, whipping blades, spiralizing blades, etc.). The blade assembly 530 may agitate, impart heat, or otherwise interact with contents within the container. Operation of the blender system 500 may impart heat into the contents within container 520.

In at least one embodiment, the blending system 500 may identify or detect whether the system 500 is interlocked through mechanical detection (e.g., push rods), user input, image recognition, magnetic detection (e.g., reed switches), electronic detection (e.g., inductive coils, a near field communication (NFC) component), or the like. Further, the system 500 may identify or detect whether the enclosure 40 is interlocked to the pedestal 30 through mechanical detection (e.g., push rods), user input, image recognition, magnetic detection (e.g., reed switches), electronic detection (e.g., inductive coils, a near field communication (NFC) component), or the like

System 500 and processes described herein generally relate to blending or food-processing systems include a food-processing disc comprising one or more inductive coils. In another aspect, one or more of the disc and/or lid may comprise an NFC component that may interact with an NFC component of a blender base. The NFC component of the blender base may receive information regarding the type of the disc and may utilize the blender base may utilize the information to determine a blending process to be utilized by the system.

It is noted that the various embodiments described herein may include other components and/or functionality. It is further noted that while described embodiments refer to a blender or a blender system, various other systems may be utilized in view of the described embodiments. For example, embodiments may be utilized in food processor systems, mixing systems, hand-held blender systems, various other food preparation systems, and the like. As such, references to a blender, blender system, and the like, are understood to include food processor systems, and other mixing systems. Such systems generally include a blender base that may include a motor, a blade assembly, and a controller. Further, such systems may include a container, a display, a memory or a processor.

As used herein, the phrases “blending process,” “blending program,” and the like are used interchangeably unless context suggest otherwise or warrants a particular distinction among such terms. A blending process may comprise a series or sequence of blender settings and operations to be carried out by the system 500. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

Further details on certain aspects may be found in U.S. Pat. No. RE45,655, filed on May 14, 2013 and granted on Aug. 18, 2015, and/or U.S. patent application Ser. No. 14/659,094, filed on Mar. 16, 2015. Also, although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A blender assembly comprising:
a base unit, said base unit housing a motor;
a pedestal extending from the base unit and defining a peripheral edge;
an enclosure providing a sound barrier to said base unit, the enclosure comprising:
a body portion including sidewalls and a base portion that define a cavity;
wherein the base portion is configured to engage the pedestal and wherein the enclosure is pivotal between a locked and unlocked position to selectively secure the enclosure to the pedestal.

2. The blender assembly of claim 1, wherein the base portion of the enclosure includes an aperture that defines an opening to receive the pedestal.

3. The blender assembly of claim 2, wherein said aperture is shaped to selectively receive the peripheral edge of the pedestal wherein rotation of the enclosure relative to the pedestal selectively locks and selectively unlocks the enclosure to the pedestal.

4. The blender assembly of claim 1, further comprising a plurality of engagement members and a plurality of engagement channels wherein the engagement members cooperate with the plurality of engagement channels to selectively secure the enclosure to the base unit.

5. The blender assembly of claim 4, wherein said engagement channels include a channel for selectively receiving said engagement member, said channel defined by a retention lip, a guide stop, a back wall and a top wall.

6. The blender assembly of claim 1, wherein the pedestal includes a plurality of engagement members and the base portion includes a plurality of engagement channels.

7. The blender assembly of claim 6, wherein said pedestal includes four engagement members and said base portion includes four engagement channels.

8. The blender assembly of claim 1, further comprising feedback confirmation to identify when the enclosure is in the locked position and the unlocked position.

9. The blender assembly of claim 8, wherein the feedback confirmation includes an electric sensor in communication with the base unit to provide audible or visual feedback confirmation.

10. An enclosure for a blender assembly that is operable to surround a blending container while on a blender, said enclosure comprising:
a body portion having opposed sidewalls and a rear wall with an open area opposed to the rear wall;
a cover pivotally attached to the body portion to cover the open area;
a base portion attached to the body portion, said base portion defines an aperture having a sidewall; and
a plurality of engagement channels extending from the sidewall of the aperture wherein the engagement channels are aligned with a plurality of engagement members positioned along a pedestal of a blender wherein the engagement members are pivotal relative to the engagement channels and wherein the enclosure is pivotal between a locked and unlocked position to relative to the pedestal.

11. The enclosure of claim 10, wherein the enclosure is rotatable relative to the pedestal to engage and to disengage the engagement members with the engagement channels.

12. The enclosure of claim 11, wherein the enclosure is rotated less than 90 degrees to selectively engage and disengage the engagement members with the engagement channels.

13. The enclosure of claim 12, wherein the enclosure is rotated less that 45 degrees to selectively engage and disengage the engagement members with the engagement channels.

14. The enclosure of claim 13, wherein the enclosure is rotated less than 20 degrees to selectively engage and disengage the engagement members with the engagement channels.

15. A method for enclosing a blender assembly comprising:
providing an enclosure having a base and sidewalls that define a cavity;
providing a blender base unit having a pedestal;
positioning the base of the enclosure on blender base unit; and
pivoting the enclosure relative to the pedestal to engage the enclosure to the blender base unit.

16. The method of claim 15, wherein the step of positioning the base of the enclosure on the blander base unit further comprises receiving, in an aperture of the base, a pedestal.

17. The method of claim 16 further comprises aligning a plurality of engagement members with a plurality of engagement channels.

18. The method of claim 17 further comprises rotating the plurality of engagement members relative to the plurality of engagement channels to engage the enclosure to the blender base unit.

19. The method of claim 18, wherein the enclosure is rotated less than 45 degrees to engage the engagement members with the engagement channels.

20. The method of claim 19, wherein the enclosure is rotated less than 20 degrees to engage the engagement members with the engagement channels.
